(19) United States
(12) Patent Application Publication
(10) Pub. No.: US 2005/0035558 A1
(43) Pub. Date: Feb. 17, 2005

(54) Closet flange seal

(76) Inventors: Anthony John Dipzinski, Grand Blanc, MI (US); Arthur William Shorey, Millington, MI (US)

Correspondence Address: Douglas A. Mullen;Dickinson Wright PLLC, Suite 800, 1901 L. Street NW, Washington, DC, 20036, US

(21) Appl. No.: 10/639,301

(22) Filed: Aug. 12, 2003

(51) Int. Cl. F16J 3/00

(52) U.S. Cl. 277/628

(57) ABSTRACT

A water closet assembly and/or closet flange seal wherein the closet flange seal includes a horn section, a body section, and a sealing fin each formed of a material having a Shore A hardness of less than about 83. The horn section includes a connecting flange, a conical wall, and a ring end wall with the conical wall being integral with and interconnecting the connecting flange and ring end wall. The body section is integral with the horn section and includes a tubular body with an outer face, a first end integral with the horn section, and a second end. The sealing fin extends outwardly from the outer body face, circumscribes the body, and is oriented in a predetermined angle relative to the outer face.

### BACKGROUND OF THE INVENTION

1. Technical Field

The present invention generally relates to an apparatus for providing a sealed connection between a water closet horn and a discharge pipe and, more particularly, a single piece sealing apparatus that performs this function.

2. Discussion

A seal is commonly disposed between a toilet or water closet and a discharge pipe. The seal prevents the toilet/pipe connection from leaking. Conventionally, this seal has taken the form of a wax ring positioned on a closet flange fixed to the discharge pipe. When the toilet is placed in position, the ring seals against the flat base of the toilet and the flange. Wax rings, while inexpensive, have a number of drawbacks. For example, it is difficult, particularly in hot weather, to store the rings in a manner that maintains their structural and geometric integrity. Further, due to their adhesive nature, initial positioning on the floor must be performed properly and removal of the rings is troublesome. Additionally, wax rings suffer from a relatively short operational life due to cracking.

In view of these and other deficiencies, some manufactures have attempted to develop alternatives to wax ring type seals. However, to date these attempts have failed to provide a commercially viable alternative. Some suppliers have attempted to use multi-material flange seals that include: a rigid plastic base material for structural integrity; a lower seal that is formed of a more flexible material, coupled to a lower portion of the base, and operatively engages the discharge pipe or closet flange when installed; and an upper flexible or adhesive seal that engages the toilet or toilet horn. However, these approaches have been found to be difficult to manufacture, unduly expensive relative to wax rings, and difficult to install.

### SUMMARY OF THE INVENTION

In view of the above, the present invention is directed to a one-piece closet flange seal that provides cost benefits, manufacturing simplicity, and installation ease relative to conventional sealing devices. More particularly, the invention is directed to a water closet assembly and/or closet flange seal wherein the closet flange seal includes a horn section, a body section, and a sealing fin each formed of a material having a Shore A hardness of less than about 83. The horn section includes a connecting flange, a conical wall, and a ring end wall with the conical wall being integral with and interconnecting the connecting flange and ring end wall. The body section is integral with the horn section and includes a tubular body with an outer face, a first end integral with the horn section, and a second end. The sealing fin extends outwardly from the outer body face, circumscribes the body, and is oriented at a predetermined angle relative to the outer face.

Further scope of applicability of the present invention will become apparent from the following detailed description, claims, and drawings. However, it should be understood that the detailed description and specific examples, while indicating preferred embodiments of the invention, are given by way of illustration only, since various changes and modifications within the spirit and scope of the invention will become apparent to those skilled in the art.

### BRIEF DESCRIPTION OF THE DRAWINGS

The present invention will become more fully understood from the detailed description given here below, the appended claims, and the accompanying drawings in which:

FIG. 1 is an exploded perspective view of a toilet assembly using the one-piece closet flange seal of the present invention;

FIG. 2 is a sectional view of the closet flange seal taken along the line 2-2 shown in FIG. 1; and

FIG. 3 is an assembled and partial sectional view of the toilet assembly shown in FIG. 1.

### DETAILED DESCRIPTION OF THE PREFERRED EMBODIMENT

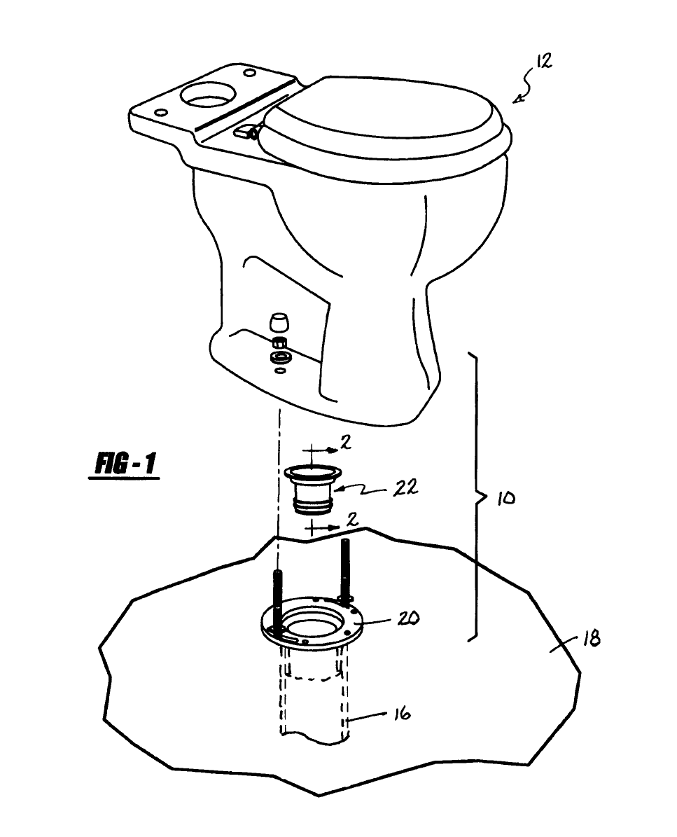

FIG. 1 shows a water closet assembly 10 that includes a water closet 12 with a horn 14 (FIG. 3), a discharge pipe 16, a closet flange 20 coupling the water closet 12 and pipe 16 to the floor 18, and a closet flange seal 22 according to the present invention. The closet flange seal 22 is operatively coupled to the water closet 12 and closet flange 20 to provide a fluid tight seal therebetween. In the present invention, the closet flange seal 22 is a one-piece, single material device having material and dimensions selected to provide a suitable seal between the water closet and closet flange. The invention provides numerous advantages over conventional sealing devices, including wax rings and conventional multiple-piece seal configurations, such as improved installation ease, reduced costs, and improved manufacturing simplicity.

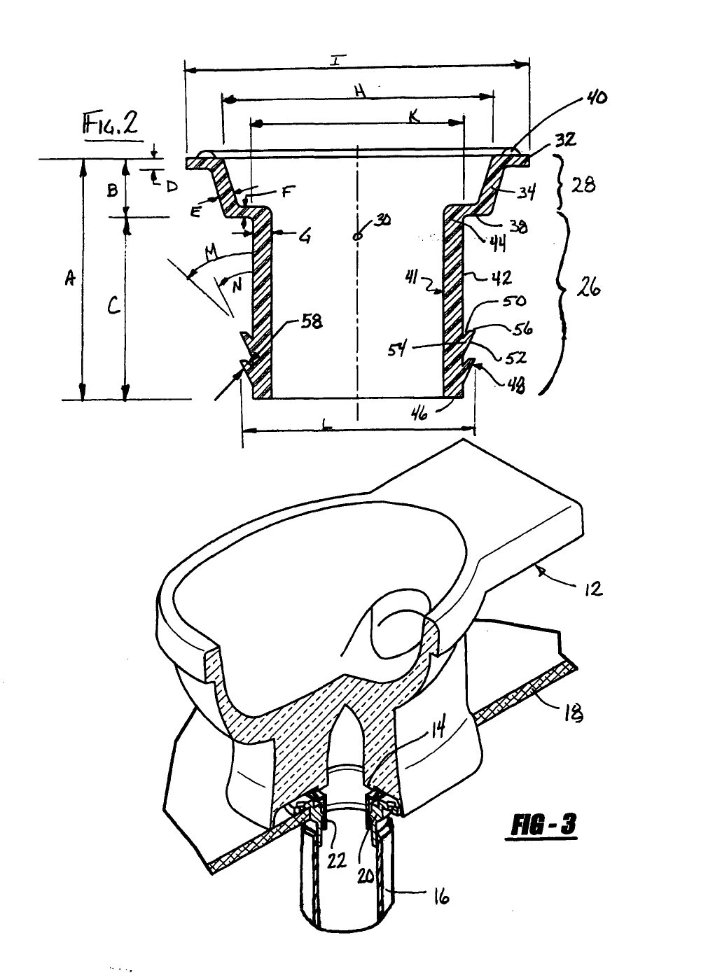

As is most clearly illustrated in FIG. 2, the closet flange seal 22 includes a body section 26 and a horn section 28, each generally concentric about a flange seal axis 30, formed of a single material, and integral with one another. The horn section 28 includes a connecting flange 32, a conical horn wall 34, and a ring end wall 38 integral with and interconnecting the body section 26 and conical horn wall 34. An adhesive 40 is disposed on the connecting flange 32 to provide a sealed coupling to the water closet 12.

The body section 26 is generally cylindrical in shape, extends from the horn section 28, and includes a wall 41 with an outer face 42, a first end 44 integral with the horn section 28, and a second end 46. One or more sealing fins 48 extend outwardly from the outer face 42 proximate the second end 46, circumscribe the body wall, and are oriented at a predetermined angle relative to the outer face 42. The sealing fins include an inner surface 50, an outer surface 52, a first end 54 integral with the body wall, and a second free end 56.

As noted above, the closet flange seal 22 of the present invention is formed of a single material thereby improving the manufacturability of the device relative to conventional sealing arrangements. Of particular note is the elimination of the need to form the sealing fins of a separate material thereby simplifying the manufacturability of the seal. To achieve a suitable seal design using a single material, the present invention addresses competing interests of wall stability and fin flexibility for seal integrity as well as overall flexibility for ease of installation.

As will be more fully described in detail below, the closet flange seal material, the relative thicknesses of the conical horn wall 34 and body wall 41, and the fin configuration are each selected to meet these goals. The following paragraphs of this detailed description describe a preferred material and closet flange seal configuration that achieves a suitable hydraulic seal at a pressure of at least 4.3 psi as well as overall flexibility to facilitate installation. Notwithstanding the following description, those skilled in the art will appreciate that numerous modifications may be made to the invention without departing from the scope of the appended claims.

In the illustrated embodiment, the horn and body sections 26 and 28 are integrally molded using a single material, preferably an elastomeric or plasticized PVC (PolyVinyl Chloride). The material is selected to have a suitable flexibility for achieving a sufficient seal while also providing sufficient structural support for the horn and body sections as well as to accommodate deflection of the sealing fins. To address these competing concerns, the preferred material has a Shore A hardness of greater than about 60 and less than about 83, preferably between about 73 and about 81, more preferably between about 73 and about 77, and even more preferably about 75. This relatively low hardness value, in comparison to materials conventionally used for the body or non-sealing portions of closet flange seals, provides greater flexibility in the non-sealing portions thereby increasing installation ease while also eliminating the need for a fin material that is different from the material of the other parts of the closet flange seal 22. For example, the flexibility of the material permits the flange seal to accommodate misalignment between the toilet horn and discharge pipe.

As noted above, the use of a single flexible material for both the structural and sealing portions of the closet flange seal 22 presents challenges concerning the configuration of the conical horn and body walls 34 and 41, respectively. For example, the walls must be sufficiently thick so that the closet flange seal 22 maintains its structural and geometric integrity during installation and use. That is, the horn and body walls are configured to provide sufficient rigidity to resist undue deformation under pressure. Otherwise, the performance of the closet flange seal may suffer during use. Further, the body wall thickness provides adequate support for proper fin deflection and sealing without adversely impacting installation ease, accommodation of misalignment, or the ability to adjust the position of the toilet during installation. For example, the wall thicknesses are limited by a number of factors including the desire to maintain flexibility to facilitate installation and the desire to accommodate horn size variations within applicable space constraints.

The closet flange seal described in detail herein is designed for use with closet flanges or drain pipes having an inner diameter of about three (3) inches. However, as will be appreciated by those skilled in the art, the inner diameter of currently used closet flanges or pipes may vary, particularly due to the use of different materials. For example, 3 inch closet flanges for which the described embodiment of the present invention is particularly suitable, commonly vary between about 3.09 and 2.93 inches. The flexibility of the closet flange seal 22, and particularly the fins 48, facilitate the use of the invention within expected tolerances. For example, the taper and angle of the fins help to hold an even pressure on the inner wall of the flange thereby providing a suitable seal within expected flange diameter variations. Moreover, by forming the body wall thickness greater than the horn wall thickness, the more rigid body wall provides greater resistance to deformations that may result in loss of concentricity during installation or use. Further, the horn wall thickness facilitates insertion of the closet flange seal inside the closet flange 20. Finally, the overall flexibility of the closet flange seal, including the horn wall, body wall, and fins allows for minor adjustments during final installation of the water closet 12.

One of the features of the present invention that assists in accommodating the competing desires of suitable flexibility for installation ease, satisfying size constraints in order to accommodate varying horn dimensions, and providing sufficient structural strength in the horn and body sections to resist undue deformation, as well as body section strength for proper fin deflection, is the relative thicknesses of the body and conical horn walls 41 and 34. As is shown in the drawings and Table 1 below, the thickness G of the body wall 41 is greater than the thickness E of the conical horn wall 34. The greater thickness in the body wall 41 provides increased support for fin deflection while not adversely impacting the suitability of the seal for varying horn sizes. The conical wall thickness E is preferably less than about 0.225 inches and, as shown in Table 1, preferably about 0.205 inches. By comparison, the thickness G of the body wall 41 is preferably greater than about 0.240 inches and, even more preferably, about 0.257 inches. In general, while the wall thicknesses may vary, particularly relative to the material durometer, the thickness E of the conical wall is preferably on the order of about 80% of the thickness G of the body wall 41.

As is noted above, the fins 48 are configured to provide a suitable seal against the closet flange 20 or discharge pipe 16 in view of the material composition of the body section, the geometry of the body wall 41 and fins 48, and in relationship to the appropriate material durometer. While the specific configuration of the fins may vary, the inner and outer surfaces 50 and 52 of the illustrated embodiment are spaced a greater distance from one another at the first end 54 than at the second end 56 thereby providing a tapering thickness 58 from the first end 54 to the second end 56. Further, the predetermine angle M of the inner fin surface 50 relative to the outer face 42 of the body is about 46 degrees and the angle N of the outer fin surface 52 relative to the outer face 42 of the body is about 27 degrees. Notwithstanding these preferred angular orientations of the fin surfaces, those skilled in the art will appreciate that the angles may be varied without departing from the scope of the invention defined by the appended claims. By way of further explanation, it is noted that the above recited angles may be varied at least +/−2° without adversely impacting the sealing performance of the fins.

The following table provides more detailed information regarding the preferred geometric configuration of the closet flange seal components. Again, these dimensions are provided to further illustrate a preferred configuration of the illustrated embodiment and not as limiting features of the invention. The reference characters listed in the table are shown in the drawings.

TABLE 1

| Reference | | |
|---|---|---|
| Character | Description Dimension | |
| A | Flange Seal Height | 3.250 inches |
| B | Horn Section Height | 0.815 inches |
| C | Body Section Height | 2.435 inches |
| D | Connecting Flange Thickness | 0.150 inches |
| E | Conical Horn Wall Thickness | 0.205 inches |
| F | Ring End Wall Thickness | 0.150 inches |
| G | Body Wall Thickness | 0.257 inches |
| H | Connecting Flange Outer Diameter | 4.700 inches |
| I | Connecting Flange Inner Diameter | 3.716 inches |
| J | Ring End Wall Outer Diameter | 3.316 inches |
| K | Body Wall Outer Diameter | 2.889 inches |
| L | Fin Outer Diameter | 3.230 inches |
| M | Inner Fin Surface Angle | 46° |
| N | Outer Fin Surface Angle | 27° |

Before turning to a brief description of a method of installing the closet flange seal 22 of the present invention, it is noted that the adhesive 40 is preferably a hot melt adhesive applied at a temperature of approximately at least 300°. Use of a suitable hot melt adhesive, such as the H433 Permanent Pressure Sensitive Adhesive distributed by Heartland Adhesives and Coatings of Germantown, Wis., creates a mechanical bond with the connecting flange when applied. More particularly, the elevated temperature of the adhesive etches into and creates a mechanical bond with the connecting flange. This mechanical bonding is attributable not only to the temperature of the adhesive but also the softness of the connecting flange material. Characteristics of suitable adhesives include a viscosity on the order of about 8,000-9,000 cps at 350° F., a ring & ball melting point (ASTM D 36-95) of about 210-220° F., and an application temperature of approximately 350-375° F. Alternatively, a rope-type or other adhesive may also be used. In this instances, it is preferred to provide the connecting flange 32 of the horn section 28 with surface discontinuities or roughness, such as by etching, to facilitate coupling of the adhesive 40 to the flange seal surface 70.

For completeness, the following description of a method of installing the closet flange seal 22 and assembling the water closet assembly 10 is provided. First, the closet flange 20 is fixed to the floor and coupled to the discharge pipe 16. Next, the closet flange seal 22 is positioned and attached to the water closet assembly 10 so that the adhesive 40 seals against the horn 14 or the water closet material surrounding the horn. Next, the water closet assembly 10 with the closet flange seal 22 attached is aligned with and displaced toward the closet flange 20 such that the fins deflect and seal against the inner surface of the closet flange 20 or discharge pipe 16. The water closet assembly is lowered to the floor and aligned with the mounting bolts. The flexibility of the closet flange seal 22 facilitates installation due in part to the flexibility of the single material forming the closet flange seal.

The foregoing discussion discloses and describes an exemplary embodiment of the present invention. One skilled in the art will readily recognize from such discussion, and from the accompanying drawings and claims that various changes, modifications and variations can be made therein without departing from the true spirit and fair scope of the invention as defined by the following claims.

1. A closet flange seal comprising:
a horn section having a connecting flange, a conical wall, and a ring end wall, the conical wall being integral with and interconnecting the connecting flange and ring end wall;
a body section integral with the horn section, the body section having a tubular body wall with an outer face, a first end integral with the horn section, and a second end;
a sealing fin extending outwardly from the outer face, circumscribing the body, and oriented at a predetermined angle relative to the outer face; and
wherein the horn section, body section, and sealing fin are each formed of a material having a Shore A hardness of less than about 83.

2. The closet flange seal of claim 1 wherein the material has a Shore A hardness of between about 73 and about 81.

3. The closet flange seal of claim 1 wherein the material has a Shore A hardness of between about 73 and about 77.

4. The closet flange seal of claim 1 wherein the material has a Shore A hardness of about 75.

5. The closet flange seal of claim 1 wherein the body wall has a thickness, the conical wall has a thickness less than the body wall thickness.

6. The closet flange seal of claim 5 wherein the conical wall thickness is approximately 80% of the body wall thickness.

7. The closet flange seal of claim 1 wherein the sealing fin has an inner surface, an outer surface, a first end integral with the body, and a second free end and wherein the inner and outer surfaces converge toward the second free end.

8. The closet flange seal of claim 1 wherein the predetermined fin angle includes the inner fin surface being oriented relative to the outer surface of the body at an angle of about 46 degrees.

9. The closet flange seal of claim 8 wherein the predetermined fin angle includes the outer fin surface relative to the outer face of the body wall at an angle of about 27 degrees.

10. The closet flange seal of claim 1 further including an adhesive positioned on said connecting flange to seal against the water closet.

11. The closet flange seal of claim 10 wherein the adhesive is a hot melt adhesive applied at an elevated temperature providing a mechanical bond with the connecting flange.

12. A water closet assembly comprising:
a water closet having a horn;
a discharge pipe;
a closet flange coupled to said water closet and said discharge pipe; and
a closet flange seal disposed between the horn and closet flange to provide a seal therebetween, said closet flange seal having a horn section and a body section, each of the horn section and body section being formed of a material having a Shore A hardness of less than about 83.

13. The water closet assembly of claim 12 wherein the material has a Shore A hardness of between about 73 and about 81.

14. The water closet assembly of claim 12 wherein the material has a Shore A hardness of between about 73 and about 77.

15. The water closet assembly of claim 12 wherein the material has a Shore A hardness of about 75.

16. The water closet assembly of claim 12 wherein the body section is integral with the horn section and the body section includes a tubular body wall with an outer face, a first end integral with the horn section, and a second end, the body section further including a sealing fin extending outwardly from the outer face, circumscribing the body, and oriented at a predetermined angle relative to the outer face, wherein the sealing fin is formed of the same material as the body and horn sections, and wherein the sealing fin sealingly engages an inner surface of the closet flange.

17. The water closet assembly of claim 16 wherein the horn section includes a connecting flange, a conical wall, and a ring end wall, the conical wall being integral with and interconnecting the connecting flange and ring end wall.

18. The water closet assembly of claim 17 wherein the body wall has a thickness and the conical wall has a thickness less than the body wall thickness.

19. The water closet assembly of claim 16 wherein the sealing fin has an inner surface, an outer surface, a first end integral with the body, and a second free end and wherein the inner and outer surfaces converge toward the second free end.

20. The water closet assembly of claim 19 wherein the predetermined fin angle includes the inner fin surface being oriented relative to the outer surface of the body at an angle of about 46 degrees.

21. The water closet assembly of claim 20 wherein the predetermined fin angle includes the outer fin surface relative to the outer face of the body wall at an angle of about 27 degrees.

22. The water closet assembly of claim 12 wherein said closet flange couples the water closet and discharge pipe to a floor, wherein the horn section of the closet flange seal includes a connecting flange defining an upper sealing surface, and wherein the water closet assembly further includes a seal material sealingly engaging the connecting flange and water closet.

23. The water closet assembly of claim 12 wherein the horn section includes a connecting flange and the water closet assembly further includes an adhesive sealingly engaging said connecting flange and water closet.

24. The water closet assembly of claim 23 wherein the adhesive is a hot melt adhesive applied to said connecting flange at an elevated temperature to create a mechanical bond with the connecting flange.
